(19) United States
(12) Patent Application Publication
(10) Pub. No.: US 2004/0260959 A1
(43) Pub. Date: Dec. 23, 2004

(54) Microprocessor equipped with power control function, and instruction converting apparatus

(75) Inventor: Takenobu Tani, Kyoto (JP)

Correspondence Address: McDERMOTT, WILL & EMERY, 600 13th Street, N.W., Washington, DC, 20005-3096, US

(73) Assignee: MATSUSHITA ELECTRIC INDUSTRIAL CO., LTD.

(21) Appl. No.: 10/825,098

(22) Filed: Apr. 16, 2004

(30) Foreign Application Priority Data
Apr. 16, 2003 (JP) P. 2003-111666

(51) Int. Cl. G06F 1/26

(52) U.S. Cl. 713/300

(57) ABSTRACT

In a microprocessor for executing an instruction program into which a power control instruction has been automatically inserted, an occurrence of a problem (bugs) which is caused by automatically inserting the power control instruction is prevented, while the power control instruction designates power control operations for individually controlling electric power with respect to operation resources of the microprocessor. Also, when the problems happen to occur, a problem which is caused by writing the instruction program can be discriminated from another problem which is caused by an instruction which is automatically inserted by a compiler.

The microprocessor is provided with: a power control register 702 for storing therein to information as to operation resources in which power control operations designated by a power control instruction should be carried out; a power control circuit 703 for outputting power control signals by which power control operations are carried out with respect to the respective operation resources based upon the information stored in the power control register 702; a power control permission register 704 into which information for indicating whether or not the power control operation is carried out has been previously set; and a gate circuit 705 for gating the respective power control signals based upon the information set by the power control permission register 704.

### BACKGROUND OF THE INVENTION

1. Field of the Invention

The present invention is related to a microprocessor equipped with a power control function, and also related to an instruction converting apparatus for optimizing an instruction program so as to be suitably executed for a predetermined microprocessor.

2. Description of the Related Art

Conventionally, in order to reduce power consumption of microprocessors, software developing persons directly write power control commands into instruction programs. FIG. 21 is a diagram for showing an example of an instruction program for executing a power control operation of a microprocessor by driving software. In this example, a data memory is not used in a section 2101. As a consequence, a software developing person inserts a command for stopping the data memory into a program portion 2102, and also, inserts another command for releasing the stop operation of the data memory into a program portion 2103 just before this data memory is again used.

When the microprocessor executes instructions, the above-described power control instruction is decoded by a decoder, and then, power control information is extracted. The extracted power control information is written into a power control register, and a power control circuit performs a power control operation in response to a state of this power control register. As previously explained, the data memory can be stopped in the section 2101 by the above-described two commands which have been inserted into instruction program.

Although the data memory has been exemplified in this example, if any other subjects whose power is controllable by commands in a microprocessor are available, then many other operation resources of this microprocessor are controllable, which involve a data register, a data bus, a calculator, a peripheral interface, and furthermore, general-purpose logical circuit elements.

However, in the above-described method, when the software, developing person writes the instruction program, this software developing person judges both a starting program portion and an end program portion of a power control operation, and directly writes a power controlling command into the instruction program, so that the developing workload by the software developing person becomes heavy. Also, when designation program portions are increased, the software developing person can hardly write control instructions in a fine manner. Furthermore, in such a case that subjects whose power should be controlled are different from each other, depending upon system structures of microprocessors such as memory constructions and port numbers of peripheral interfaces, programs specific to the respective machine sorts of these microprocessors are necessarily required. As a result, it is practically difficult that software can be commonly used, and can be substituted with each other.

To solve the above-described problem, an instruction converting apparatus such as a compiler has been proposed in Japanese Patent Application No. 2003-17374. In this instruction converting apparatus, such information has been previously stored in a table and this information is related as to whether or not the respective operation resources are actuated, depending upon sorts of instructions which constitute an instruction program. Then, the instruction program is analyzed by using this table, and then, a power control instruction is inserted based upon an analysis result.

Very recently, in connection with increases in software volumes, problems (bugs) are easily left in the software, so that security aspects of the software can be hardly guaranteed. On the other hand, when bugs are revealed after software has been shipped as software products, these software products must be collected, and the software must be rewritten by the correct software in a free charge, which may conduct considerable losses.

In the above-described technical idea described in Japanese Patent Application No. 2003-17374, since the power control instructions are automatically inserted by the instruction converting apparatus such as the compiler, there is a certain possibility that problems (bugs) are produced by automatically inserting the power control instructions. Also, even if a bug can be discovered when a software product is debugged, it is practically difficult to judge as to whether this bug is caused by the instruction program written by the software developing person, or by the instruction which is automatically inserted by the instruction converting apparatus such as the compiler.

For instance, in connection with increases in functions of mobile appliances, higher requirements for reducing power consumption are made. Thus, very recently, strong demands of lowering power consumption are made in many electronic appliances. Under such a circumstance, the method for manually writing the power control commands into the instruction program by the software developing person can hardly satisfy these demands. As a consequence, such a method as a compiler for automatically inserting power control instructions is necessarily required. However, possibilities at which problems (bugs) occur since the power control instructions are automatically inserted may cause a large problem.

Also, since hardware related to power control operation is used so as to stop operations of other hardware, there are large possibilities that initial problems as to the hardware may occur. As a consequence, with respect to power control operations, it is also important to discriminate a software problem (program bugs) from a hardware problem. However, in the conventional method in which the software developing person directly writes the power control commands into the instruction program, since the programmer makes up the software containing the power control commands, it is practically difficult to discriminate the software problem (program bugs) from the hardware problem. This software/hardware problem discrimination is similarly applied to the method for automatically inserting the power control instructions into the instruction program by employing the compiler.

### SUMMARY OF THE INVENTION

The present invention has been made to solve the above-explained problems of the prior art, and therefore, has an object to provide such a microprocessor equipped with a power control function and such an instruction converting apparatus. That is, in an instruction converting method realized by a compiler and the like, which analyzes an instruction program and automatically inserts power control instructions into the analyzed instruction program, the microprocessor and the instruction converting apparatus can prevent an occurrence of a problem which is caused by automatically inserting the power control instructions, and thus can improve security aspects of software. Furthermore, when problems occur, the microprocessor and the instruction converting apparatus can discriminate a problem which is caused by a command program written by a software developing person from another problem which is caused by automatically inserting an instruction by a compiler, and also, can discriminate a problem which is caused by hardware related to a power control operation from another problem which is caused by software.

To solve the above-described problems, a microprocessor, recited in claim 1 of the present invention, is featured by such a microprocessor equipped with a power control function, comprising: power control permission setting means to which information as to whether or not a power control operation is carried out is previously set; and power control output control means for finally controlling an output of a power control signal in accordance with the information set in the power control permission setting means when a power control instruction is executed, the power control instruction separately designating power control operations with respect to operation resources of the microprocessor.

A microprocessor, recited in claim 2, is featured by such a microprocessor as recited in claim 1, further comprising: a power control register for storing thereinto information as to operation resources whose power control operations should be carried out, which are designated by the power control instruction; a power control circuit for outputting power control signals for controlling electric power with respect to the respective operation resources based upon the information stored in the power control register; and a gate circuit for gating the respective power control signals in accordance with the information set to the power control permission setting means.

In accordance with the microprocessor recited in claim 1, or claim 2, since the power control permission setting means can determine as to whether or not the power control operation, when a security aspect of software wants to have higher priority than low power consumption, the power control is not permitted and the security aspect can be secured. Also, since permission/no permission of a power control operation is switched when debugging of an instruction program is carried out, a software problem which is caused by an instruction code written by a software developing person may be discriminated from another problem which is caused by a power control instruction inserted by an instruction converting operation.

A microprocessor, recited in claim 3, is featured by such a microprocessor equipped with a power control function, comprising: processor state judging means for holding information as to whether or not a power control operation is carried out, which has been previously set every program ID applied to each of instruction programs, and for judging as to whether or not a program ID of an instruction program under execution corresponds to the program ID which has been-set so as to perform the power control operation; and power control output control means for finally controlling an output of a power control signal in accordance with a judgement result of the processor state judging means as to the instruction program under execution when a power control instruction is executed, the power control instruction separately designating power control operations with respect to operation resources of the microprocessor.

A microprocessor, recited in claim 4, is featured by such a microprocessor as recited in claim 3, further comprising: a power control register for storing thereinto information as to operation resources whose power control operations should be carried out, which are designated by the power control instruction; a power control circuit for outputting power control signals for controlling electric power with respect to the respective operation resources based upon the information stored in the power control register; and a gate circuit for gating the respective power control signals in accordance with the judgement result of the processor state judging means.

In accordance with the microprocessor recited in claim 3, or claim 4, a decision can be made as to whether or not the power control operation is actually carried out based upon such a setting condition as to whether or not the instruction program under execution performs the power control operation. For instance, the power control operation can be permitted in such an instruction program which has been developed by a reliable software developing person, whereas the power control operation cannot be permitted in such an instruction program which has been developed by an unreliable software developing person, so that the security aspect in the execution of the instruction program can be increased.

An instruction converting apparatus, recited in claim 5, is featured by such an instruction converting apparatus for optimizing an instruction program so as to suitably execute the optimized instruction program by a predetermined microprocessor, comprising: power control managing means for extracting power control management information by referring to an instruction statement which is written in the instruction program; power control information analyzing means for detecting an operation resource based upon the power control management information extracted by the power control managing means, the operation resource being not actuated for an instruction section having a predetermined length when the predetermined microprocessor is operated; and power control instruction applying means for applying an instruction related to a power control operation to the instruction program based upon the detected result of the power control information analyzing means.

An instruction converting apparatus, recited in claim 6, is featured by such an instruction converting apparatus as recited in claim 5 wherein: the power control management information contains information for designating the predetermined length of the instruction section; and the power control information analyzing means changes the predetermined length of the instruction section based upon the power control management information.

An instruction converting apparatus, recited in claim 7, is featured by such an instruction converting apparatus as recited in claim 5, or claim 6 wherein: the instruction converting apparatus is further comprised of: instruction-independent operation resource table storing means for storing thereinto information as to whether or not each of the operation resources of the predetermined microprocessor is actuated every instruction; and the power control information analyzing means detects such an operation resource which is not actuated for the instruction section having the predetermined length when the predetermined microprocessor is operated based upon the information stored in the instruction-independent operation resource table storage means.

In accordance with the instruction converting apparatus recited in claim 5 to claim 7, a software developing person designates both a section for performing a power control operation and a level of the power control operation by employing an instruction statement when an instruction is formed, so that the power control operation at the arbitrary level can be carried out only in the section for requiring the power control operation. As a result, such a problem that the code size is increased and the operating speed is lowered can be suppressed in minimum, and the power control operation can be carried out in a fine mode. Also, it is possible to design that the power control operation is not carried out at such a program portion that the problem as to the security aspect may easily occur by inserting; and substituting the power control instruction. As a consequence, the security aspect of the instruction program can be furthermore increased.

An instruction converting apparatus, recited in claim 8, is featured by such an instruction converting apparatus for optimizing an instruction program so as to suitably execute the optimized instruction program by a predetermined microprocessor, comprising: power control analyzing means for detecting an operation resource which is not actuated for an instruction section having a predetermined length when the predetermined microprocessor is operated; and power control instruction applying means for applying an instruction related to a power control operation to the instruction program based upon the detection result of the power control information analyzing means; wherein: the power control information analyzing means is comprised of: instruction reassembling means for reassembling the instruction program in such a manner that an instruction section is made long, during which an actuation of an operation resource can be stopped.

In accordance with the instruction converting apparatus recited in claim 8, since the instruction program can be automatically rearranged in such a manner that the instruction section becomes long during which the actuation of the operation resource can be stopped, the instruction section during which the operation resource is not actuated can be made long, which is detected by the power control information analyzing means, and thus, the power consumption when the instruction program is not executed can be reduced.

An instruction converting apparatus, recited in claim 9, is featured by such an instruction converting apparatus as recited in claim 8 wherein: the instruction reassembling means corresponds to instruction rearranging means for rearranging instructions while maintaining an instruction dependent relationship established in the instruction program.

In accordance with the instruction converting apparatus recited in claim 9, while the correspondence relationship of the instructions contained in the instruction program is maintained, the instructions can be rearranged in such a manner that the instruction section is made long during which the actuation of the operation resource can be stopped. As a consequence, the instruction section can become long during which the operation resource is not actuated, which is detected by the power control information analyzing means, and thus, the power consumption can be effectively reduced.

An instruction converting apparatus, recited in claim 10, is featured by such an instruction converting apparatus as recited in claim 8 wherein: the instruction reassembling means corresponds to instruction replacing means for replacing one instruction contained in the instruction program by a replaceable instruction having the same process result as that of the one instruction.

In accordance with the instruction converting apparatus recited in claim 10, the instructions contained in the instruction program can be replaced by the replaceable instructions in such a manner that the instruction section is made long during which the actuation of the operation resource can be stopped. As a consequence, the instruction section can become long during which the operation resource is not actuated, which is detected by the power control information analyzing means, and thus, the power consumption can be effectively reduced.

An instruction converting method, recited in claim 11, is featured by such an instruction converting method for optimizing an instruction program so as to suitably execute the optimized instruction program by a predetermined microprocessor, comprising: a power control managing step for extracting power control management information by referring to an instruction statement which is written in the instruction program; a power control information analyzing step for detecting an operation resource based upon the power control management information extracted in the power control managing step, the operation resource being not actuated for an instruction section having a predetermined length when the predetermined microprocessor is operated; and a power control instruction applying step for applying an instruction related to a power control operation to the instruction program based upon the detected result of the power control information analyzing step.

An instruction converting method, recited in claim 12, is featured by such an instruction converting method as recited in claim 11 wherein: the power control management information contains information for designating the predetermined length of the instruction section; and the power control information analyzing step changes the predetermined length of the instruction section based upon the power control management information.

An instruction converting method, recited in claim 13, is featured by such an instruction converting method as recited in claim 11, or claim 12 wherein: the power control information analyzing step refers to an instruction-independent operation resource table which stores thereinto information as to whether or not each of the operation resources of the predetermined microprocessor is actuated every instruction in order to detect such an operation resource which is not actuated for the instruction section having the predetermined length when the predetermined microprocessor is operated.

In accordance with the instruction converting method recited in claim 11 to claim 13, a software developing person designates both a section for performing a power control operation and a level of the power control operation by employing an instruction statement when an instruction is formed, so that the power control operation at the arbitrary level can be carried out only in the section for requiring the power control operation. As a result, such a problem that the code size is increased and the operating speed is lowered can be suppressed in minimum, and the power control operation can be carried out in a fine mode. Also, it is possible to design that the power control operation is not carried out at such a program portion that the problem as to the security aspect may easily occur by inserting and substituting the power control instruction. As a consequence, the security aspect of the instruction program can be furthermore increased.

An instruction converting method, recited in claim 14, is featured by such an instruction converting method for optimizing an instruction program so as to suitably execute the optimized instruction program by a predetermined microprocessor, comprising: a power control analyzing step for detecting an operation resource which is not actuated for an instruction section having a predetermined length when the predetermined microprocessor is operated; and a power control instruction applying step for applying an instruction related to a power control operation to the instruction program based upon the detection result of the power control information analyzing step; wherein: the power control information analyzing step is comprised of: an instruction reassembling step for reassembling the instruction program in such a manner that an instruction section is made long, during which an actuation of an operation resource can be stopped.

In accordance with the instruction converting method recited in claim 14, since the instruction program can be automatically rearranged in such a manner that the instruction section becomes long during which the actuation of the operation resource can be stopped, the instruction section during which the operation resource is not actuated can be made long, which is detected by the power control information analyzing step, and thus, the power consumption when the instruction program is not executed can be reduced.

An instruction converting method, recited in claim 15, is featured by such an instruction converting apparatus as recited in claim 14 wherein: the instruction reassembling step rearranges instructions while maintaining an instruction dependent relationship established in the instruction program.

In accordance with the instruction converting method recited in claim 15, while the correspondence relationship of the instructions contained in the instruction program is maintained, the instructions can be rearranged in such a manner that the instruction section is made long during which the actuation of the operation resource can be stopped.

An instruction converting method, recited in claim 16, is featured by such an instruction converting apparatus as recited in claim 14 wherein: the instruction reassembling step replaces one instruction contained in the instruction program by a replaceable instruction having the same process result as that of the one instruction.

In accordance with the instruction converting method recited in claim 16, the instructions contained in the instruction program can be replaced by the replaceable instructions in such a manner that the instruction section is made long during which the actuation of the operation resource can be stopped. As a consequence, the instruction section can become long during which the operation resource is not actuated, which is detected by the power control information analyzing step, and thus, the power consumption can be effectively reduced.

A microprocessor, recited in claim 17, is featured by such a microprocessor wherein: the microprocessor executes the instruction program converted by the instruction converting apparatus recited in any one of claim 5 to claim 10 so a to separately perform a power control operation with respect to an operation resource built in the microprocessor.

A microprocessor, recited in claim 18, is featured by such a microprocessor wherein: the microprocessor executes the instruction program converted by the instruction converting method recited in any one of claim 11 to claim 16 so as to separately perform a power control operation with respect to an operation resource built in the microprocessor.

### BRIEF DESCRIPTION OF THE DRAWINGS

FIG. 1 is a diagram for indicating a basic arrangement of an instruction converting apparatus and a processing stage thereof.

FIG. 2 is a diagram for showing a structural example of an instruction-independent operation resource table.

FIG. 3 is a diagram for representing an output example of instruction-dependent operation resource use data by an instruction-dependent operation resource analyzing means.

FIG. 4 is a diagram for explaining an output example of power control instruction data by a power control information detecting means.

FIG. 5 is a diagram for representing an insertion example of a power control instruction by a power control instruction applying means.

FIG. 6 is a diagram for showing a structural example of a power control register.

FIG. 7 is a block diagram for showing an arrangement of a microprocessor according to a first embodiment of the present invention.

FIG. 8 is a block diagram for showing an arrangement of a microprocessor according to a second embodiment of the present invention.

FIG. 9 is a diagram for indicating an example of an ID-to-power control table according to the second embodiment of the present invention.

FIG. 10 is a diagram for showing an example of an instruction program for designating a power control section by employing a comment statement.

FIG. 11 is a diagram for indicating a correspondence example between levels of power control operations and contents of the power control operations.

FIG. 12 is a diagram for indicating an arrangement of an instruction converting apparatus and a process stage thereof, according to a third embodiment of the present invention.

FIG. 13 is a diagram for indicating an arrangement of an instruction converting apparatus and a process stage thereof, according to a fourth embodiment of the present invention.

FIG. 14 is a diagram for indicating an example as to an instruction program formed before instructions are rearranged, and instruction-dependent operation resource use data.

FIG. 15 is an explanatory diagram for explaining a dependent relationship among instructions.

FIG. 16 is a diagram for indicating a structure of an instruction rearranging means.

FIG. 17 is a diagram for indicating an example as to an instruction program formed after instructions are rearranged, and instruction-dependent operation resource use data.

FIG. 18 is a diagram for indicating an arrangement of an instruction converting apparatus and a process stage thereof, according to a fifth embodiment of the present invention.

FIG. 19 is a diagram for indicating an example as to an instruction program formed before instructions are replaced, and instruction-dependent operation resource use data.

FIG. 20 is a diagram for indicating an example as to an instruction program formed after instructions are replaced, and instruction-dependent operation resource use data.

FIG. 21 is a diagram for showing the example as to the instruction program for performing the power control operation by the conventional microprocessor.

### DESCRIPTION PREFERRED EMBODIMENTS

Referring now to drawings, embodiment modes of the present invention will be described.

### First Embodiment Mode

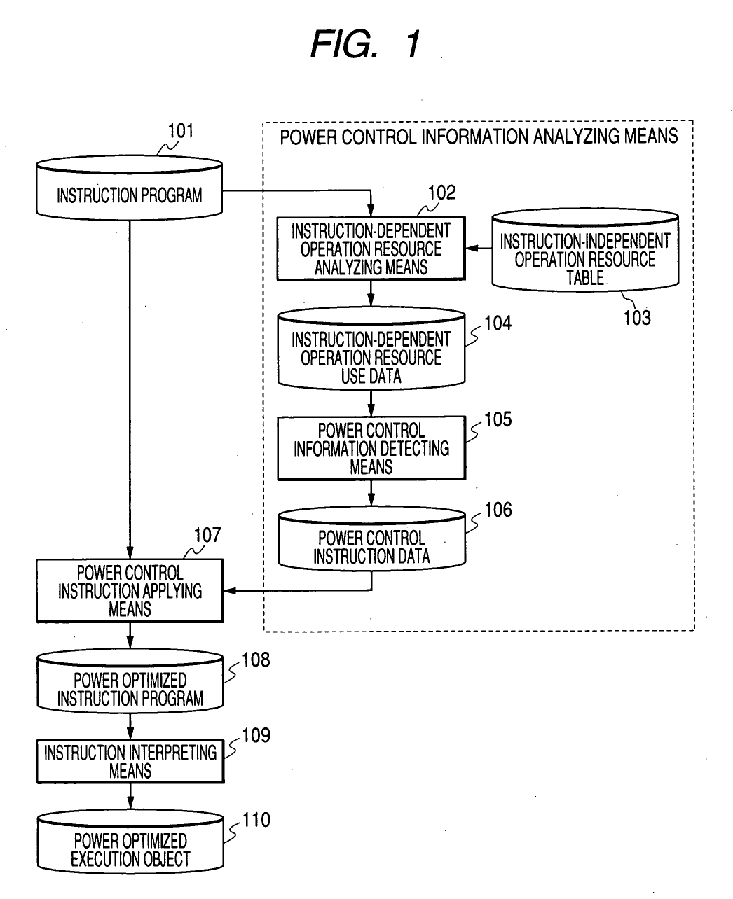

FIG. 1 is related to a microprocessor equipped with a power control function according to a first embodiment of the present invention, and is a diagram for representing both a construction and a process stage of an instruction converting apparatus such as a compiler. The instruction converting apparatus converts a command program written by a user into an execution object form a type instruction program. If an instruction interpreting means (will be discussed later) is omitted, then the instruction converting apparatus may be such an apparatus for converting an execution object type instruction program.

In FIG. 1, reference numeral 101 indicates an instruction program which is executed by a microprocessor. The instruction program 101 may be expressed by any instruction format, e.g., an instruction string of an assembler program which is described by a mnemonic code, or an instruction string which is written by a program language such as C language and FORTRAN. In the below-mentioned description, an explanation is made by employing an example of an assembler program which has been mainly written by a mnemonic code.

A power control information analyzing means of the instruction converting apparatus is constituted by an instruction-dependent operation resource analyzing means 102, an instruction-independent operation resource table 103, and a power control information detecting means 105. The instruction-independent operation resource table 103 has previously stored thereinto such information that any of operation resources within the microprocessor is actuated every instruction.

The instruction-dependent operation resource analyzing means 102 refers to the instruction-independent operation resource table 103 every instruction which constitutes the instruction program 101, extracts information for indicating that any of operation resources is operated, and outputs instruction-dependent operation resource use data 104. The power control information detecting means 105 analyzes the instruction-dependent operation resource use data 104 in a time sequential manner, judges that if a power control instruction is inserted into any position, then an electric power consumption amount can be reduced, and thereafter outputs power control instruction data 106. The power control instruction is to stop an actuation of an operation resource, or to start an actuation of an operation resource.

A power control instruction applying means 107 inserts either an instruction for stopping the actuation of the operation resource or another instruction for starting the actuation of this operation resource into the instruction program 101 based upon the power control instruction data 106, and produces a power optimized instruction program 108. An instruction interpreting means 109 interprets a program language of the power optimized instruction program 108 into a machine language, and produces/outputs a power optimized execution object 110 corresponding to a machine language instruction code string which should be executed by the microprocessor. In such a case that the instruction program 101 has already been made in the execution object format, the instruction interpreting means 109 may be omitted.

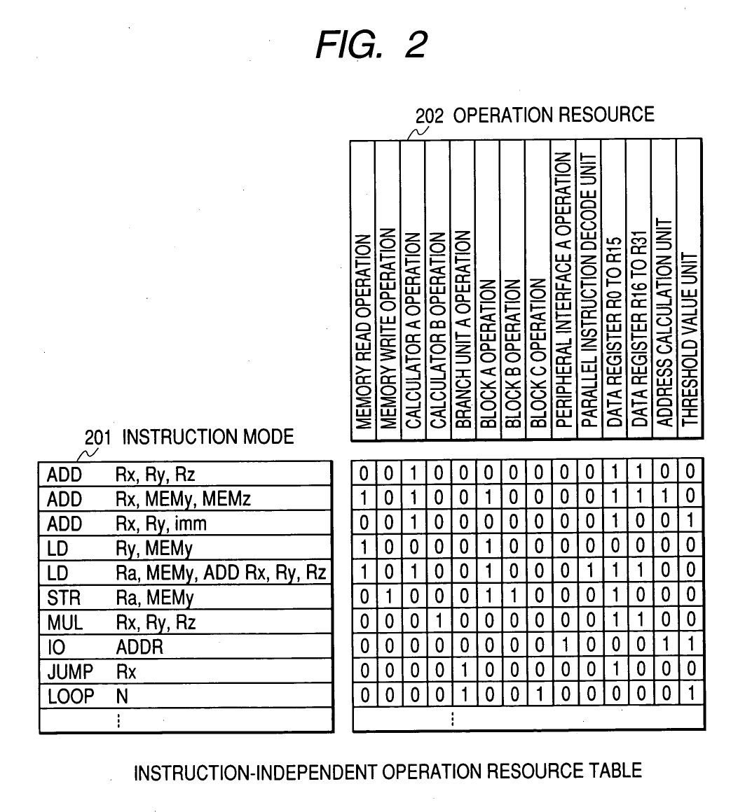

FIG. 2 is a diagram for indicating a structural example of the instruction-independent operation resource table 103. The instruction-independent operation resource 103 corresponds to a two-dimensional table having two fields, namely a field 201 indicative of instruction modes, and a field 202 indicative of operation resources employed in the microprocessor. Values contained in the instruction-independent operation resource table 103 indicate such facts as to whether or not the respective operation resources are actuated when the respective instruction modes are executed. It should be understood that the format of the instruction-dependent operation resource table 103 is not always limited only to the format shown in FIG. 2. In such a case that parameters are required in addition to instruction modes and operation resources, an instruction-dependent operation resource table may constitute a three-dimensional table.

In this example, numeral “1” contained in the instruction-independent operation resource table 103 represents that an operation resource is actuated, and numeral “0” contained in this table 103 shows that an operation resource is not actuated. For example, in the case of “ADD Rx, Ry, Rz” corresponding to an adding instruction between registers, while the microprocessor is operated, only “calculator A operation”, “data register R0-R15”, and “data register R16-R31” are actuated. As a result, numeral “1” is described at corresponding positions within this table 103. Since other operation resources are not actuated, numeral “0” is described at corresponding positions within this table 103. Similarly, in the case of “LD Ra MEMy” corresponding to a read instruction of a memory, only “memory Read operation” and “block A operation”, where numeral “1” is written in this table 103, are actuated. In this case, both a value of “0” and a value of “1” are not important, but own such a purpose capable of discriminating “operation resource is actuated” from “operation resource is not actuated”.

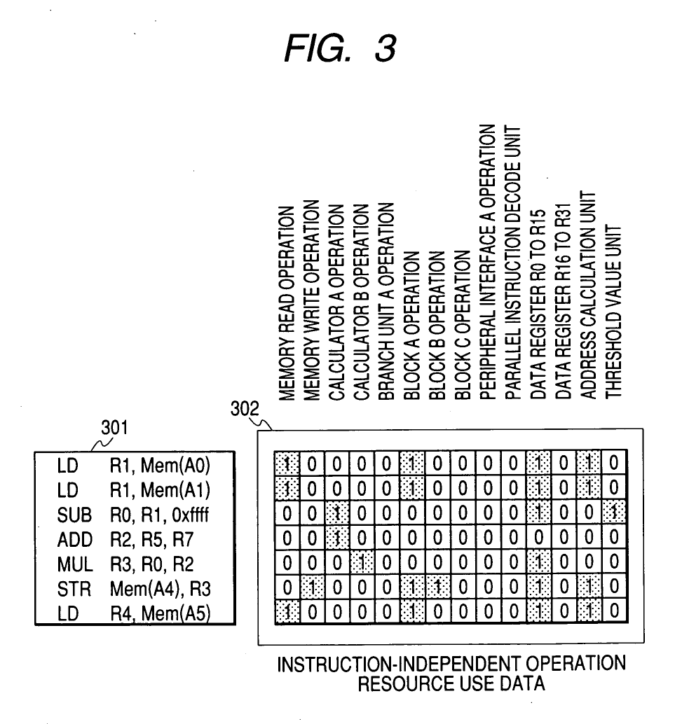

Next, referring now to FIG. 3, operations of the instruction-dependent operation resource analyzing means 102 will be explained while exemplifying such a case that an instruction program is 301. When the instruction-dependent operation resource analyzing means 102 receives the instruction program 301 as an input program, the instruction-dependent operation resource analyzing means 102 retrieves as to whether or not the received instruction program 301 is made coincident with an instruction mode field of the instruction-independent operation resource table 103 every instruction, and then, outputs resources within the microprocessor, which correspond to the respective instructions, in such a manner that operation resources 302 are outputted. In the operation resources 302, such a condition is shown that operation resources which become “1” every instruction are operated when instructions are executed. The instruction-dependent operation resource analyzing means 102 executes the above-described analyzing operation as to each of the instructions which constitute the instruction program, and thus, produces the instruction-dependent operation resource use data 104.

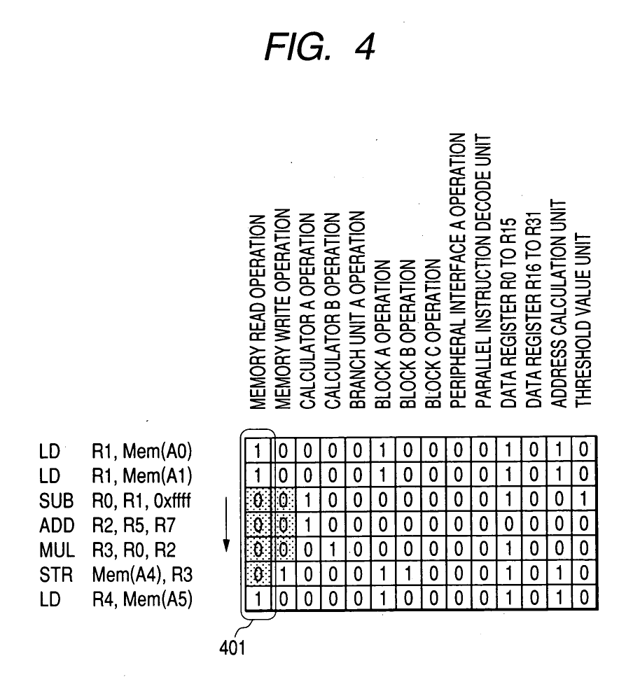

Subsequently, operations of the power control information detecting means 105 will now be explained with reference to FIG. 4. The power control information detecting means 105 analyzes as to whether or not an operation resource is actuated along an instruction direction (time sequential direction) as to the instruction-dependent operation resource use data 104 which is outputted by the resource-dependent-operation resource analyzing means 102. As one example of this analyzing method, a description is made of such a method for detecting continued “0”. In the instruction-dependent operation resource use data 104 shown in FIG. 4, information “0” represents that the microprocessor does not perform an actuation of an operation resource in the execution of this instruction. The power control information detecting means 105 can detect that such an operation resource is not actuated during a predetermined instruction section by detecting “0” continued for a constant instruction section, for instance, three instruction sections as to the instruction-dependent operation resource use data 104.

While an analysis of “memory Read operation” is exemplified in FIG. 4, a description is made of such a case that an operation resource is detected which is not actuated for three, or more instruction sections. In accordance with a data string indicated by numeral “401” and corresponding to “memory Read operation”, “memory Read operation” is not required during 4 instructions defined from an SUB instruction up to an STR instruction. As a consequence, the power control information detecting means 105 detects this operation resource.

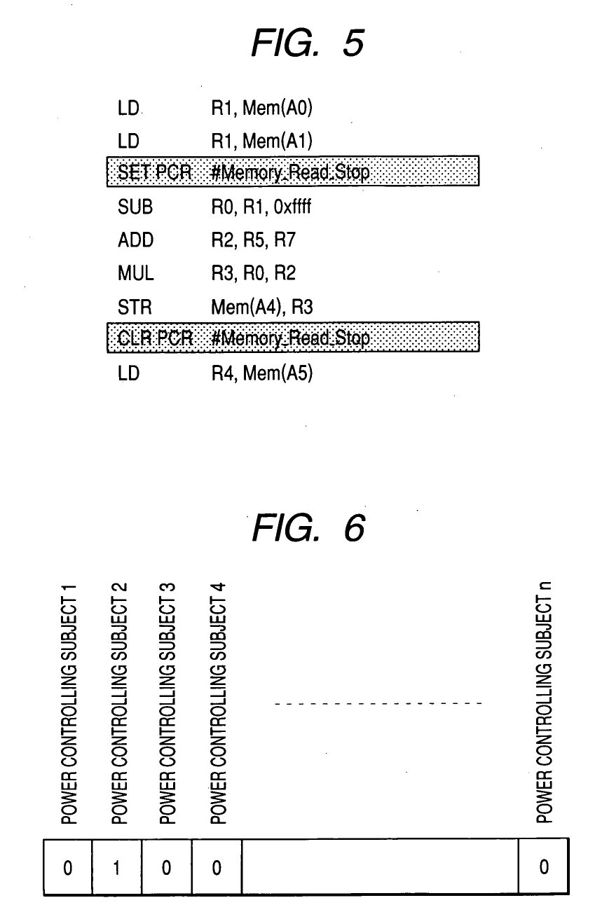

While the same instruction program as that of FIG. 4 is exemplified, a further explanation is made of the power control instruction applying means 107. FIG. 5 shows an insertion example of a power control instruction. As indicated in FIG. 5, the power control instruction applying means 107 inserts such an instruction code just before the SUB instruction, and inserts an instruction for starting a circuit operation just after the STR instruction based upon the power control instruction data 106 outputted from the power control information detecting means 105. This instruction code requests to stop a circuit operation related to “memory Read operation”. As a result, the circuit operation stop related to “memory Read operation” can be realized without requiring a decode every instruction, and the power consumption required for “memory Read operation” can be reduced within this section.

In this example, the stoppable section of the operation resource longer than, equal to the three instruction sections is detected. As to the instruction section in which the operation stop can be carried out which is detected by the power control information detecting means 105, an optimum power control level may be arbitrarily set as a length longer than, or equal to 1 section by each of application programs operated by the microprocessor and a system.

Alternatively, the microprocessor may be constructed in such a manner that when a program is compiled, a user designates a power control level by employing an option. For instance, when the user designates an option 1 so as to compile the program, stopping of operation is carried out with respect to such an operation resource which is not actuated for three, or more sections. When the user designates an option 2 so as to compile the program, stopping of operation is carried out with respect to such an operation resource which is not actuated for five, or more sections. When power control instructions are excessively inserted, there is a risk that a code size of a program is increased due to an increase of instructions, and lowering of operating speeds is caused. As previously explained, since the options are designated, a software developing person can perform the power control operation, while considering the code size of the program and the operating speed. It should also be noted that the designation subject of the power control level is not limited to the length of the section, but may be applied to various subjects. For example, operation resources which are to be power-controlled, and/or methods of power control operations may be conceived. As the power control methods, a clock frequency is lowered and/or stopped, and a supply of electric power is interrupted.

It should also be noted that in the example of FIG. 4, “memory Write operation” is not also required within three instructions defined from the SUB instruction up to a MUL instruction. As a consequence, in this example, since this information is detected, a power control operation can be carried out on the upper stream side, as compared with the case that only the power control operations for the individual operation resources are carried out. In other words, not only the control instructions related to “memory Read operation” and “memory write operation” are applied to the instruction program, but also, such a control instruction for completely stopping the memory, and the memory control circuit itself may be applied to the instruction program.

Alternatively, when such a definition is made that instructions for performing both the normal calculation such as an adding calculation and a bit shift, and either stopping or starting of an actuation of an operation resource are recognized as a single instruction in the instruction specification, the information related to the power control operation may be applied to an instruction program by not inserting the power control instruction, but by replacing the instruction.

The above-described instruction converting apparatus may be realized by way of a computer program. Since this computer program is assembled in an assembler, if a software developing person assembles the instruction program 101, then this software developing person may form the program up to a power optimized execution object 110. As a result, the software developing person merely writes the instruction program to assemble the instruction program 101 without paying any attention thereto, so that the power consumption of the microprocessor can be reduced lower than that of the conventional microprocessor. Apparently, while the instruction converting apparatus is not assembled in the assembler, this instruction converting apparatus may be constituted as an independent-power controlling instruction converting program.

Also, in such a case that a writing language of a software developing person corresponds to such a programming language as C language and FORTLAN, a program may be alternatively assembled in a compiler. Since a programming language is employed, the software developing person may more simply write a program.

In the above-explained description, the instruction program written by the software developing person is analyzed, and after the power optimization is carried out, the instruction program written in the programming language is translated into the instruction program (execution object format) written by the machine language. Alternatively, after the instruction program has been translated into the execution object, even if the execution object is analyzed to form the power optimized execution object, then there is no problem. Furthermore, such as instruction converting apparatus is realized by a circuit, and then this instruction converting circuit may be assembled in a microprocessor.

The power optimized execution object 110 the instruction of which has been converted by the instruction converting apparatus so as to be formed is executed by the microprocessor. When the microprocessor executes an instruction, this microprocessor extracts power control information by decoding a power control instruction inserted in the power optimized execution object 110 by an instruction decoder. The extracted power control information is written in a power control register, and then, a power control circuit executes a power control operation in response to a status of this power control register.

FIG. 6 is a diagram for indicating a structural example of the power control register. In FIG. 6, respective power control subjects correspond to the field indicative of the operation resources of the instruction-independent operation resource table, for example, correspond to “memory Read operation”, “memory Write operation”, “calculator A operation”, “calculator B operation”, and the like. An operation resource of a power control subject whose bit becomes “1” in the power control register constitutes such a subject whose circuit operation is stopped. In FIG. 6, since a power control subject 2 is bit “1”, this subject constitutes such a power control subject whose circuit operation is stopped, whereas power control subjects 1, 3, and 4 do not constitute such power control subjects whose circuit operations are stopped.

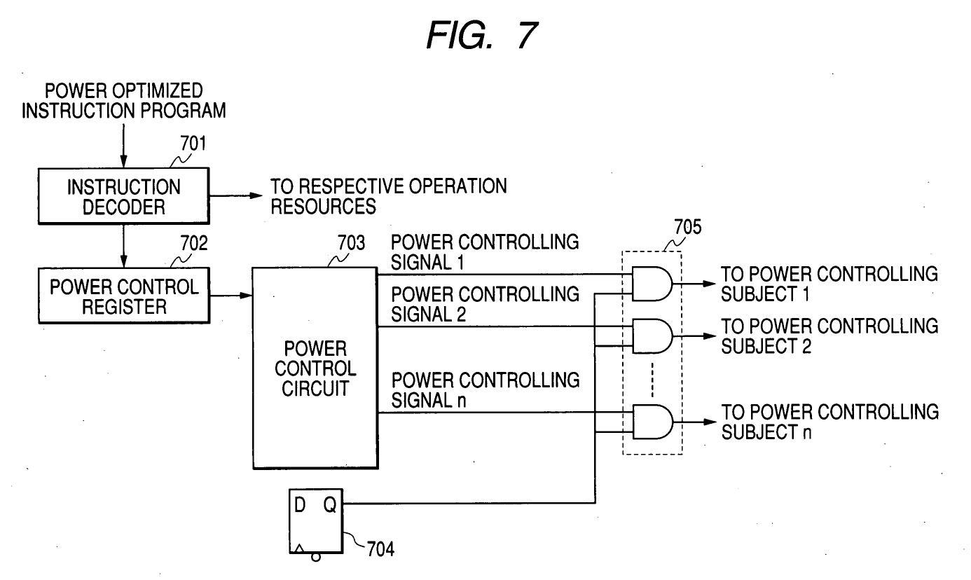

FIG. 7 is a block diagram for indicating an arrangement of the power control function in the microprocessor according to the first embodiment of the present invention. In FIG. 7, an instruction decoder 701 decodes an instruction so as to apply decoded instructions to the respective operation resources. Also, when the instruction decoder 701 decodes a power control instruction, this instruction decoder 701 extracts power control information. A power control register 702 corresponds to such a register which holds the power control information extracted by the instruction decoder 701, and a power control circuit 703 corresponds to a circuit for performing a power control operation based upon the power control information written in the power control register.

Furthermore, a power control permission register 704 corresponds to such a register for determining as to whether or not the microprocessor performs the power control operation. An output signal from the power control permission register 704 constitutes input signals to a gate circuit group 705 in combination with power control signals outputted by the power control circuit 703. Output signals of this gate circuit group 705 are supplied to the respective power control subjects.

A more concrete operation will now be explained. The power control circuit 703 refers to a value of the power control register 70, and sets a signal level of a power control signal to an “H” level. This power control signal is supplied to such a power control subject whose circuit operation is stopped. When a power control operation is permitted, the power control permission register 704 outputs a “H”-level signal, whereas when a power control operation is not permitted, this power control permission register 704 outputs an “L”-level signal. As a result, when the power control operation is permitted, the power control signal outputted from the power control circuit 703 is directly outputted to the power control subject. However, when the power control operation is not allowed, the power control signal outputted from the power control circuit 703 is suppressed by a gate circuit, so that only an “L”-level signal is supplied to the power control subject. The circuit operations of the respective power control subjects are stopped when the signal levels of the supplied power control signals become “H” levels.

Since the power control permission register 704 is provided, when a safety characteristic of operation wants to have higher priority than low power consumption, the power control is not permitted and the safety characteristic can be secured. Also, since permission/no permission of a power control operation is switched when debugging of an instruction program is carried out, a software problem which is caused by an instruction code written by a software developing person may be discriminated from another problem which is caused by a power control instruction inserted by an instruction converting operation. In this connection, a problem which is caused by a power control instruction inserted by an instruction converting operation involves both a problem which is caused by hardware related to a power control operation, and a software problem which is caused by an inserted power control instruction.

Further, since the power control permission register 704 is employed, the hardware problem related to the power control operation may also be discriminated from other problems. Concretely speaking, firstly, a software developing person develops software and executes this developed software under such a condition that a power control operation is not permitted. A problem occurred at this time is assumed as (1). Even in this case, it is so assumed that the software developing person writes a power control instruction in minimum. Next, the developed software is executed while the power control operation is permitted. A problem occurred at this time is assumed as (2). As a consequence, a difference between the problem (1) and the problem (2) may constitute such a problem which is caused by the hardware related to the power control operation. Furthermore, the instruction of the developed software is converted by employing the instruction converting apparatus for automatically inserting the power control instruction, and then, the converted software is executed while the power control operation is permitted. A problem occurred at this time is assumed as (3). As a result, it is so assumed that a difference between the problem (2) and the problem (3) may constitute such a software problem which is caused by the power control instruction inserted by the instruction converting operation. Since the debugging operation is carried out while the instruction converting operation is carried out and the permission/no permission of the power control operation are switched, various sorts of problems can be discriminated from each other.

### Second Embodiment Mode

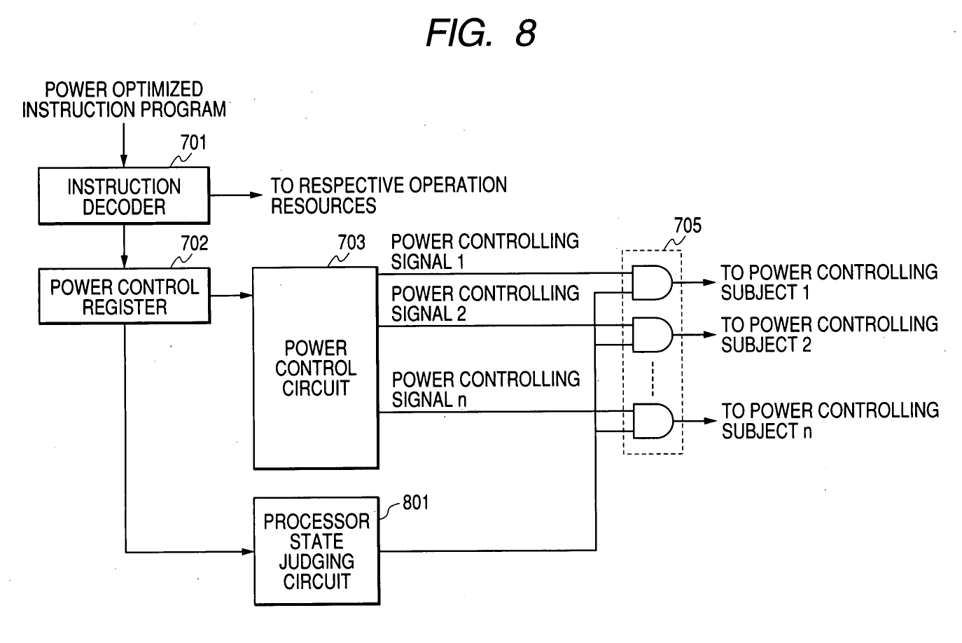

FIG. 8 is a block diagram for representing an arrangement of a power control function in a microprocessor according to a second embodiment of the present invention. It should be noted that the same reference numerals shown in FIG. 7 will be employed as those for denoting the same structural elements indicated in FIG. 8, and explanations thereof are omitted. In the power control function indicated in FIG. 8, instead of the power control permission register 704 of FIG. 7, a processor state judging circuit 801 is employed.

Generally speaking, a program ID is applied to an instruction program which is executed by a microprocessor every program portion. In the microprocessor, authority is set by the above-described program ID. In this second embodiment, the processor state judging circuit 801 judges a program ID, so that this processor state judging circuit 801 determines as to whether or not a power control operation is carried out. When the processor state judging circuit 801 judges that the power control operation is carried out, the processor state judging circuit 801 sets a signal level of an output signal to an “H” level, which is supplied to the gate circuit group 705. When the processor state judging circuit 801 judges that the power control operation is not carried out, the processor state judging circuit 801 sets a signal level of an output signal to an “L” level, which is supplied to the gate circuit group 705. As a result, when the processor state judging circuit 801 judges that the power control operation is not carried out, since the gate circuit group 705 outputs only the “L”-leveled signal, the power control operation is not carried out.

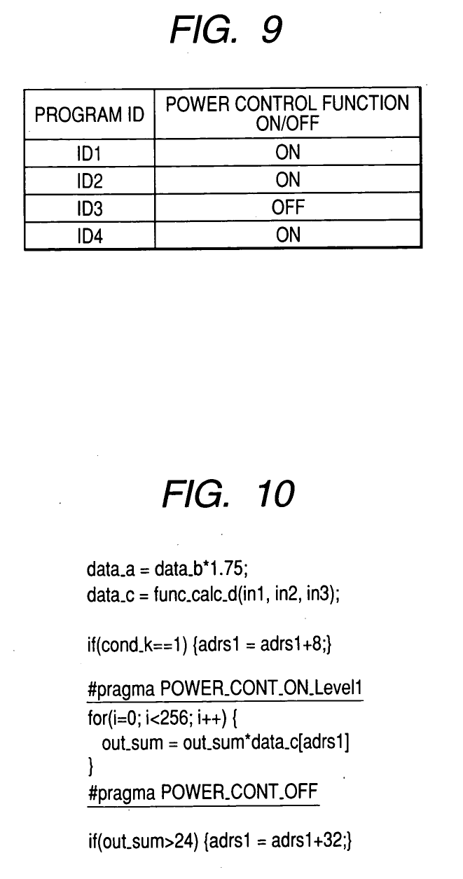

FIG. 9 indicates an example of an ID-to-power control table which is held by the processor state judging circuit 801. This table indicates a correspondence relationship between program IDs and permission/no-permission of power control operations. When a program ID is entered to the processor state judging circuit 801, the processor state judging circuit 801 retrieves as to whether or not this entered program ID is made coincident with the program ID of the ID-to-power control table, so that this processor state judging circuit 801 determines as to whether or not the power control operation is carried out. In accordance with the example of FIG. 9, when the program ID corresponds to “ID1”, “ID2”, and “ID4”, the processor state judging circuit 801 sets a signal level of an output signal outputted to the gate circuit group 705 into an “H” level, and also, power control signals outputted by the power control circuit 703 are directly outputted to power control subjects. When the program ID corresponds to “ID3”, since the processor state judging circuit 801 sets a signal level of an output signal outputted to the gate circuit group 705 into an “L” level, a power control signal outputted by the power control circuit 703 is suppressed, so that a power control operation is not carried out.

As previously described, since the decision is made as to whether or not the power control operation is carried out by way of the program ID, for example, the power control operation can be permitted in such an instruction program which has been developed by a reliable software developing person, whereas the power control operation cannot be permitted in such an instruction program which has been developed by an unreliable software developing person, so that a security aspect in the execution of the instruction program can be increased.

There are many cases, namely, a program ID is set every program portion (for example, every task) within a program, or a program ID is set as to an entire program. Among these setting methods, if a method is capable of setting authority, then this setting method may be covered by the technical scope of the present invention.

### Third Embodiment Mode

In this third embodiment, when a software developing person forms an instruction program, the software developing person designates both a section during which a power control operation is carried out and a level of the power control operation by employing an instruction statement. An instruction converting apparatus controls a power control information detecting means with reference to the above-explained instruction statement. In other words, as to a section designated in such a manner that the power control operation is carried out based upon the instruction statement, such an operation resource is detected which can be power-controlled in response to a designated level, whereas as to a section to which the power control operation is not designated, an operation resource which can be power-controlled is not detected.

FIG. 10 is a diagram for indicating an example of an instruction program written by a software developing person. In this third embodiment, a description is made of such an example that a comment statement is employed as one example of the instruction statement. The software developing person inserts a comment sentence “#pragma POWER_CONT_ON_Level 1” into the beginning portion of the section for executing power control information so as to instruct a commencement of the power control operation, and inserts a comment sentence “#pragma POWER_CONT_OFF” into a final portion of the section for executing the power control information in order to instruct a completion of the power control operation. In a section which is sandwiched by the above-explained two comment statements, the power control operation is carried out at the level of “Level 1”.

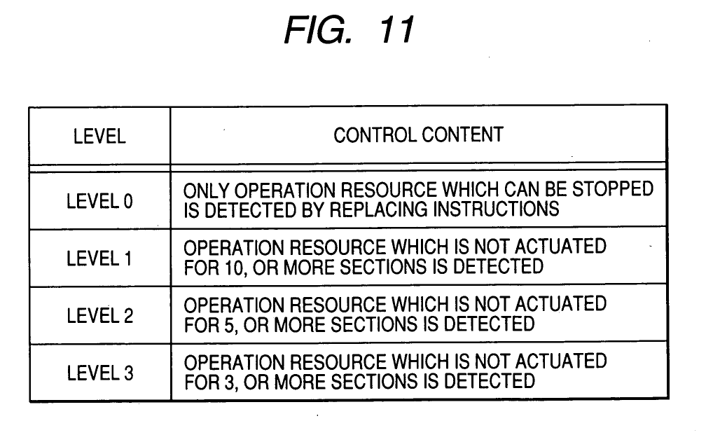

FIG. 11 is a diagram for indicating an example of a correspondence relationship between levels of the power control operation according to this third embodiment and a power control operation which is actually carried out. In this example, at a level 0, only an operation resource is detected in which a substitutable instruction has been defined and such a problem that a code size is increased does not occur. At a Level 1, a Level 2, and a Level 3, a detection is made of operation resources which are not actuated for sections longer than, or equal to 10 sections, 5 sections, and 3 sections, respectively.

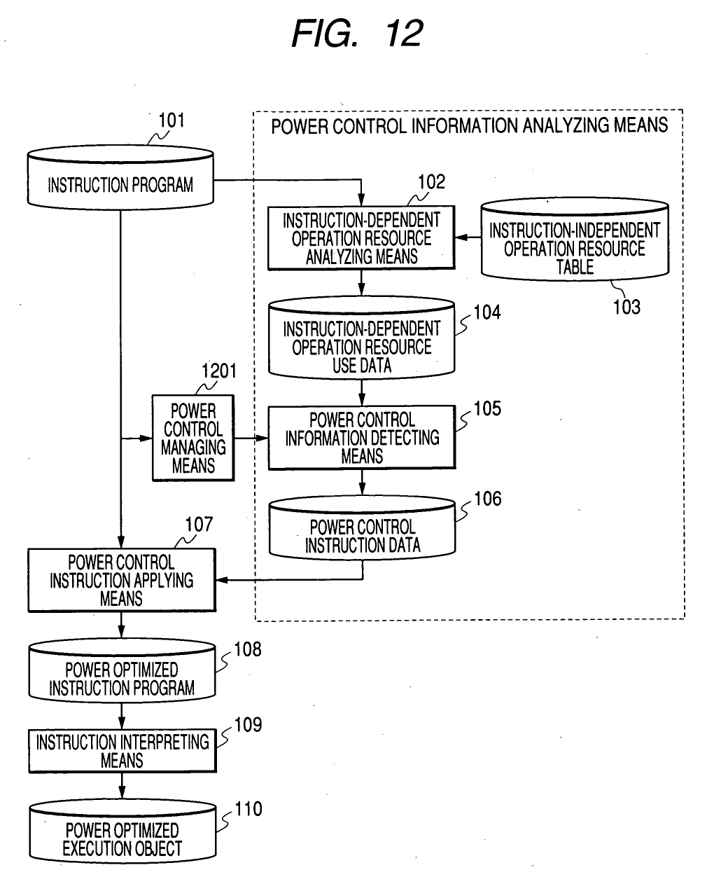

FIG. 12 is a diagram for indicating an arrangement of an instruction converting apparatus equipped with a power control function according to the third embodiment of the present invention, and a process stage thereof. In this drawing, it should be understood that the same reference numerals shown in FIG. 1 will be employed as those for denoting the same structural elements, and explanations thereof are omitted. In FIG. 12, this instruction converting apparatus is provided with a power control information managing means 1201 in addition to the arrangement of the above-described instruction converting apparatus shown in FIG. 1.

The power control information managing means 1201 extracts a comment statement started from “#” from an instruction program. When the extracted comment statement comments that the power control operation is turned ON, the power control information managing means 1201 instructs the power control information detecting means 105 to detect such an operation resource whose power can be controlled at a designated level. When the extracted comment statement comments that the power control operation is turned OFF, the power control information managing means 1201 stops the function of the power control information detecting means 105.

In this third embodiment, the power control operation at the arbitrary level can be carried out only in the section for requiring the power control operation. As a result, such a problem that the code size is increased and the operating speed is lowered can be suppressed in minimum, and the power control operation can be carried out in a fine mode.

Furthermore, in this third embodiment, it is possible to design that the power control operation is not carried out at such a program portion that the problem as to the security aspect may easily occur by inserting and substituting the power control instruction. As a consequence, the security aspect of the instruction program can be furthermore increased. For instance, at a program portion where a large number of condition branching operations are employed, a program bug may readily occur since a power control instruction is inserted and substituted. Thus, in accordance with this embodiment, it is possible to control that no power control operation is carried out at such a program portion.

It should also be noted that the subject of the power control level designation is not limited only to this embodiment, but maybe applied to the following methods. For instance, a method for designating an operation resource may be alternatively employed in which only a power control operation related to a memory is carried out at the level 0; a power control operation related only to a memory and a calculator for an arithmetic calculation is carried out at the Level 1; and power control operations related to all of operation resources are carried out at the Level 2. Also, another method may be employed in which methods of controlling electric power (e.g., lowering of clock frequency, stop of oscillating clock frequency, and interrupt of supplying of electric power) are changed.

### Fourth Embodiment Mode

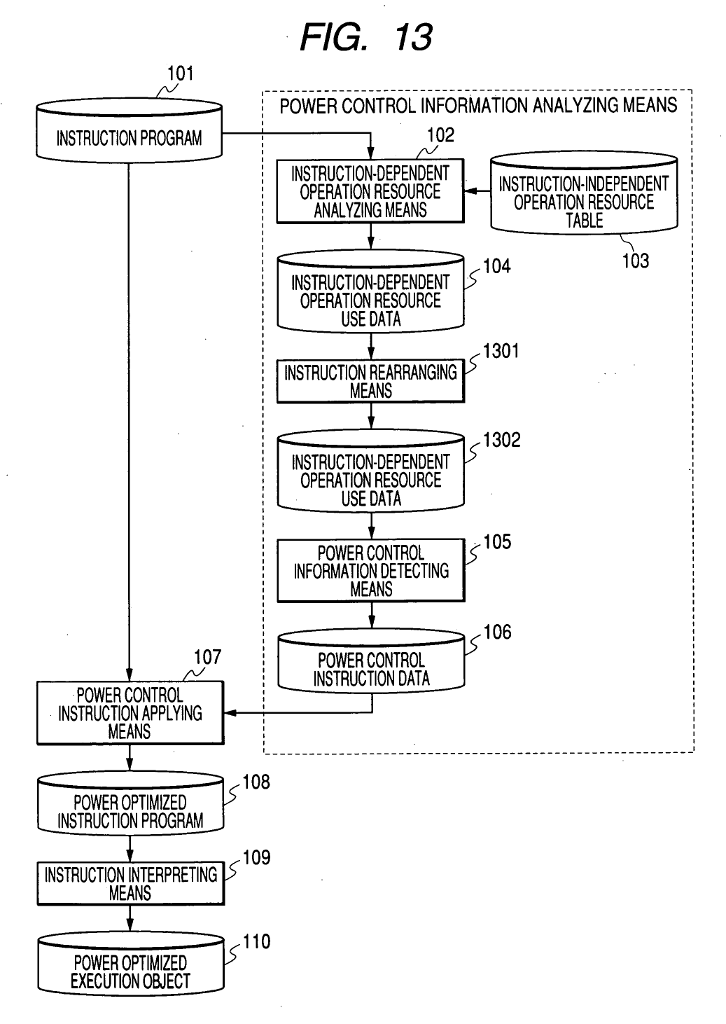

FIG. 13 is a diagram for indicating an arrangement of an instruction converting apparatus equipped with a power control function according to a fourth embodiment of the present invention, and a process stage thereof. In this drawing, it should be understood that the same reference numerals shown in FIG. 1 will be employed as those for denoting the same structural elements, and explanations thereof are omitted. In FIG. 13, the instruction converting apparatus is provided with an instruction rearranging means 1301 and instruction-dependent operation resource use data 1302 corresponding to an output of this instruction rearranging means 1301 in addition to the arrangement of the instruction converting apparatus shown in FIG. 1.

Priority degrees have been previously set to operation resources by considering power consumption thereof. In the instruction rearranging means 1301, instruction-dependent operation resource use data 104 is inputted, and a dependent relationship among instructions in an instruction program is analyzed so as to extract such instructions which can be rearranged. Then, a sequence of instructions is rearranged which have been extracted in such a manner that an operation resource having a higher priority degree can be stopped in a longer section. The rearranging result is outputted as the instruction-dependent operation resource use data 1302 to the power control information detecting means 105.

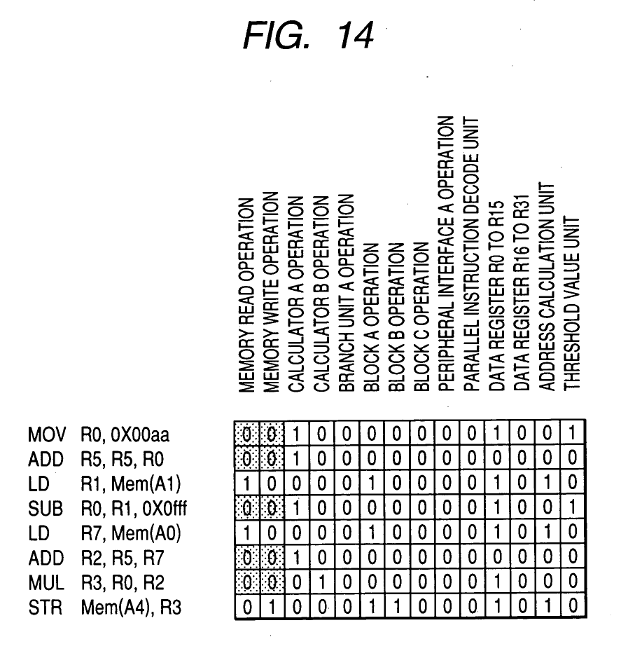

FIG. 14 indicates both an example of an instruction program formed before instructions are rearranged, and the instruction-dependent operation resource use data 104 of this instruction program. In an explanation of this fourth embodiment, it is so assumed that a memory operation owns the highest priority degree. In the instruction program shown in FIG. 14, since a “memory Read operation” is executed in “LD R1, Mem(A1)” and “LD R1, Mem(A1)”, although “memory Write operation” maybe stopped for 7 instruction sections, there is no way except that this “memory Write operation” can be stopped only for 2 instruction sections in maximum as the memory operation. As a consequence, in this fourth embodiment, the instruction rearranging means 1301 analyzes the dependent relationship among the instructions, and rearranges the instructions, so that the instruction section where the operation resource can be stopped can be made longer, and the power consumption can be further reduced.

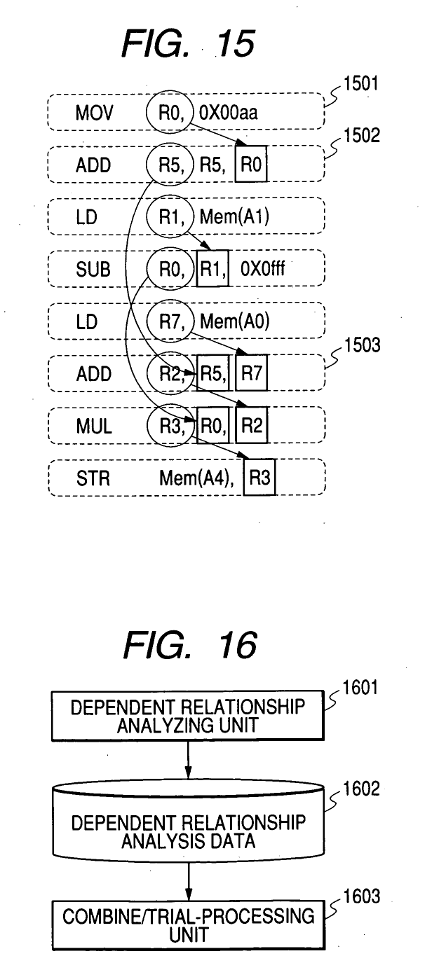

FIG. 15 is an explanatory diagram for explaining a dependent relationship among instructions in the instruction program of FIG. 14. For instance, a value of a register R0 used in an instruction 1502 is determined by another instruction 1501. As a result, if a sequence between the instruction 1501 and the instruction 1502 is rearranged, then process results are made different from each other, and therefore this sequence cannot be rearranged. Also, a value of a register R5 employed in an instruction 1503 is determined by another instruction 1502. As a result, a sequence between the instruction 1502 and the instruction 1503 cannot also be rearranged. The above-described relationship is referred to as a “dependent relationship”. In this drawing, sequences between circles and rectangles cannot be rearranged which are connected to each other by arrows. However, even when other sequences are rearranged, a correct calculation can be carried out.

FIG. 16 is a diagram for indicating a structure of the instruction rearranging means 1301 in more detail. As to the entered instruction-dependent operation resource use data 104, the dependent relationship among the instructions is analyzed by the dependent relationship analyzing unit 1601, and thereafter, such an information related to the dependent relationship is applied to this instruction-dependent operation resource use data 104, and then, the resulting data is outputted as dependent relationship analysis data 1602 to a combine/trial-processing unit 1603. While the dependent relationship is maintained, the combine/trial-processing unit 1603 combine/trial-processes rearrangements of the instruction programs, and then rearranges the instructions in such a manner that a section in which an operation of an operation resource having a high priority degree can be stopped may become the longest section.

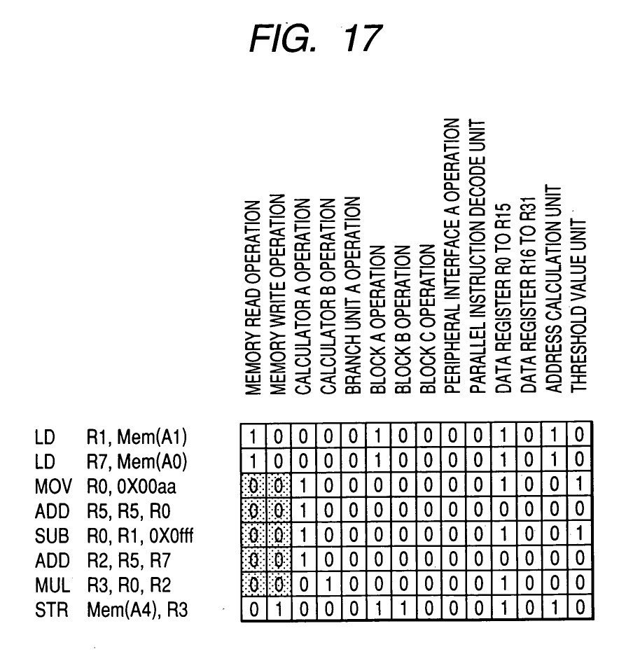

FIG. 17 indicates both an instruction program formed after instructions have been rearranged, and instruction-dependent operation resource use data 1302 of this instruction program. In this fourth embodiment, two LD instructions are rearranged in such a manner that execution sequences may become faster while the dependent relationship is not destroyed. As a result, since the operation of “memory Read operation” can also be stopped for 5 instruction sections in a similar manner to “memory Write operation”, the operations as the entire memory can be stopped for 5 instruction sections.

As previously explained, since the instruction rearranging means 1301 is employed, the instructions can be rearranged in such a manner that such an instruction section can be prolonged during which the operation of the operation resource having the high priority degree, namely having the large power consumption is stopped. As a result, the power consumption can be further lowered.

It should also be noted that the instruction rearranging means 1301 is not limited only to the above-explained embodiment, but may be realized by any other means capable of rearranging instructions so as to realize lower power consumption. For instance, while priority degrees are provided with respect to individual operation resources, such a method for causing an actuation of an operation resource having a high priority degree to be stopped for a longer instruction section is made simpler. However, power consumption is not always lowered by rearranging instructions, depending upon an instruction program. As a consequence, various other methods may be conceived, namely, a method for rearranging instructions in such a manner that a total section of instruction sections during which operations of operation resources are stopped becomes long. Alternatively, there is another method that power consumption predictable for respective operation resources is previously defined, and instructions are rearranged, while monitoring how much electric power is consumed when a microprocessor is actually operated.

Since this fourth embodiment is combined with the third embodiment, instructions may be alternatively rearranged only at a predetermined program portion of an instruction program. As a consequence, the instructions may be preferably rearranged only at such a program portion that rearranging of instructions becomes effective. In particular, rearranging of instructions may become effective at a program portion such as a loop program portion which is executed in a high frequency.

### Fifth Embodiment Mode

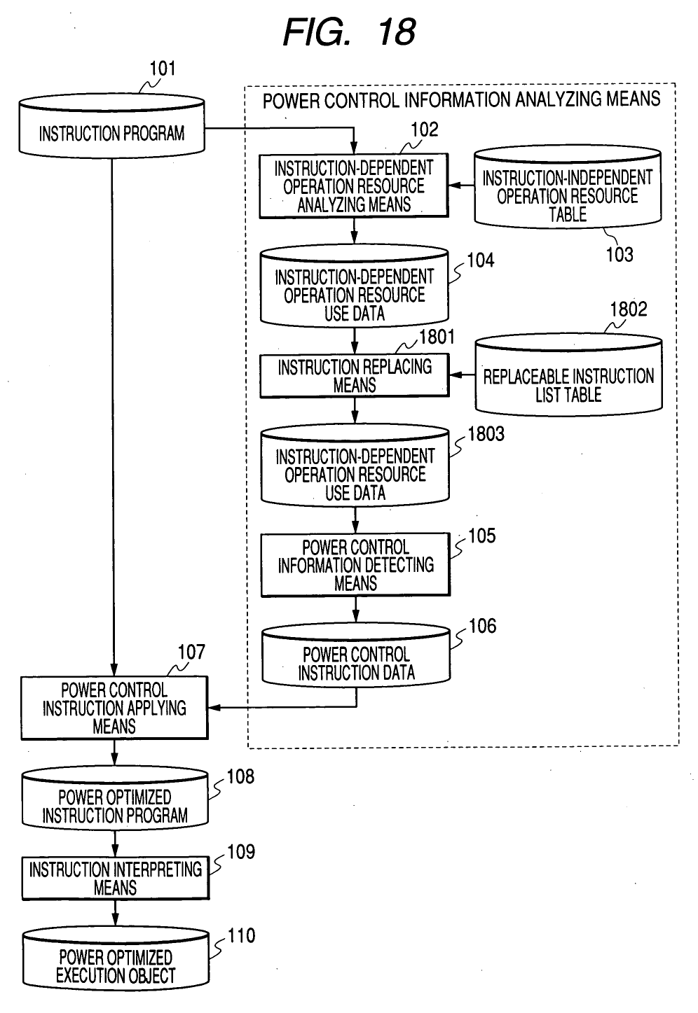

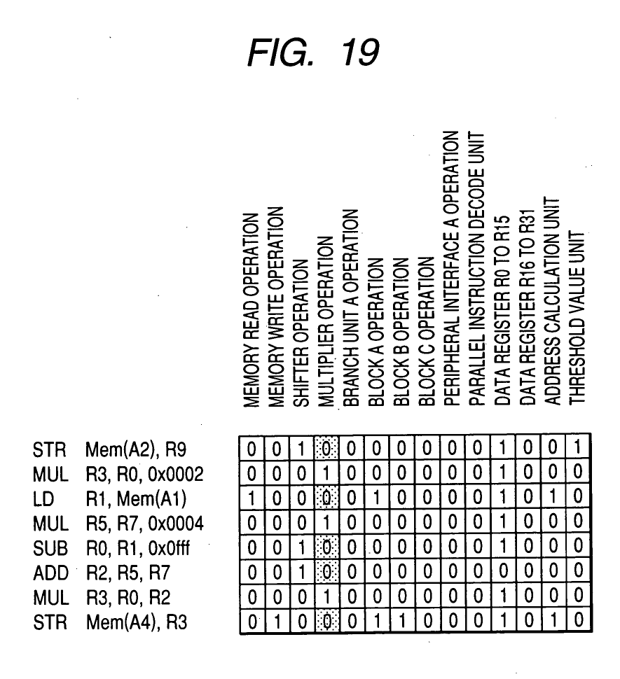

FIG. 18 is a diagram for indicating an arrangement of an instruction converting apparatus equipped with a power control function according to a fifth embodiment of the present invention, and a process stage thereof. In this drawing, it should be understood that the same reference numerals shown in FIG. 1 will be employed as those for denoting the same structural elements, and explanations thereof are omitted. In FIG. 18, the instruction converting apparatus is provided with a replaceable instruction list table 1802, an instruction replacing means 1801, and instruction-dependent resource use data 1803 corresponding to an output of this instruction replacing means 1801 in addition to the arrangement of the instruction converting apparatus shown in FIG. 1. The replaceable instruction list table 1802 stores thereinto a list of replaceable instructions.

In this case, a replaceable instruction implies such an instruction that even when instructions are replaced with each other, the same process results are obtained. Priority degrees have been previously set to operation resources owned by a microprocessor by considering power consumption thereof. The instruction replacing means 1801 refers to the replaceable instruction list table 1802, and if an instruction section may become long during which an actuation of an operation resource having a high priority degree can be stopped as a result of an instruction replacing operation, then the instruction replacing means 1801 actually replaces the instructions with each other.

FIG. 19 indicates an example of an instruction program formed before instructions are replaced, and instruction-dependent operation resource use data 104 of this instruction program. In this case, symbol “MUL R3, R0, 0×0002” implies such an instruction that a value of a register “R0” is multiplied by 2, and then, the resultant value is stored in a register “R3”. As a result, such an instruction (SFT R3, R0, 0×0001) for shifting the value stored in the register R0 by 1 bit in an upper grade, and a processed result thereof are not different from each other. However, there is a difference as to whether a calculator to be used corresponds to a multiplier, or a shifter. A similar relationship may be established between an instruction “MUL R3, R0, 0×0004” and another instruction “SFT R3, R0, 0×0002”. It is so assumed that the priority degree of the multiplier is higher than that of the shifter. In the instruction program of FIG. 19, the operation of the shifter can be stopped for 3 instruction sections, whereas the operation of the multiplier can be stopped only for 2 instruction sections. Therefore, in this fifth embodiment, the instruction replacing means 1801 replaces the above-explained two MUL instructions by the SFT instruction.

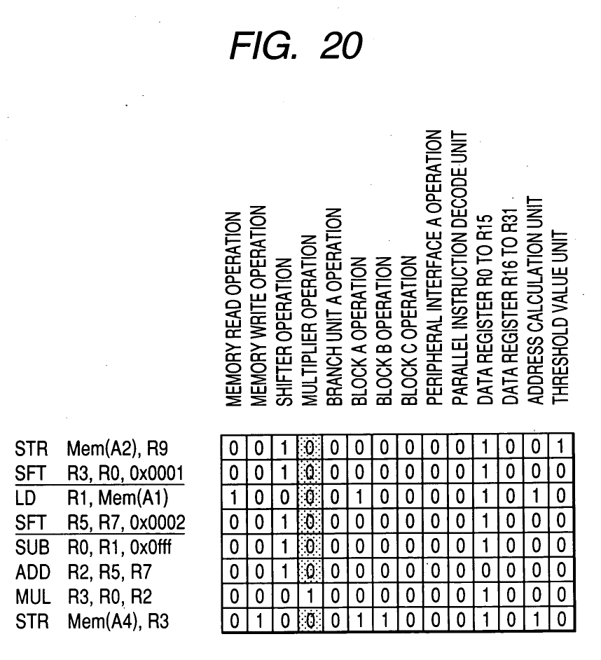

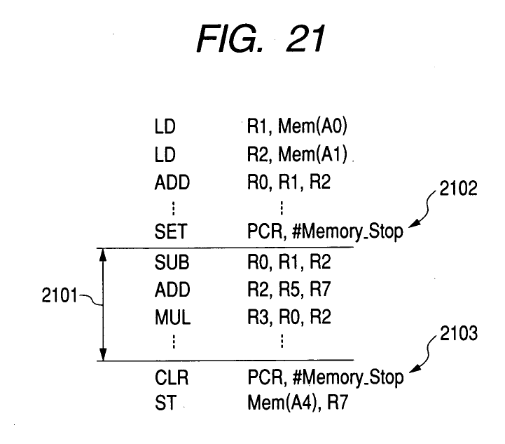

FIG. 20 shows an instruction program formed after instructions have been replaced, and instruction-dependent operation resource use data 1803. Since an MUL instruction is replaced by an SFT instruction, an operation of a multiplier can be stopped for 6 instruction sections. As a result, power consumption of the microprocessor can be further reduced.

It should also be understood that the instruction replacing means 1801 is not limited only to the above-explained embodiment, but may be realized by any other means capable of replacing instructions with each other so as to realize lower power consumption. For instance, while priority degrees are provided with respect to individual operation resources, such a method for causing an operation of an operation resource having a high priority degree to be stopped for a longer instruction section is made simpler. However, power consumption is not always lowered by replacing instructions with each other, depending upon an instruction program. As a consequence, various other methods may be conceived, namely, a method for replacing instructions in such a manner that a total section of instruction sections during which actuations of operation resources are stopped becomes long. Alternatively, there is another method that power consumption predictable for respective operation resources is previously defined, and instructions are replaced with each other, while monitoring how much electric power is consumed when a microprocessor is actually operated.

Since this fifth embodiment is combined with the third embodiment, instructions may be alternatively rearranged only at a predetermined program portion of an instruction program. As a consequence, the instructions may be preferably rearranged only at such a program portion that rearranging of instructions becomes effective. In particular, rearranging of instructions may become effective at a program portion such as a loop program portion which is executed in a high frequency.

Also, as the method for stopping operations of operation resources in the present invention, various stopping methods may be conceived, for instance, a supply of a clock is stopped; a clock frequency is lowered, an applied voltage is controlled; a threshold voltage of a transistor which constitutes an operation resource is controlled, and the like. If methods are capable of bringing operation resources to lower power consumption conditions, then no specific limitation is made.

As previously described, in accordance with the present invention, setting of the power control permitting means can be determined, or the decision as to whether or not the power control operation is carried out can be made by the program ID of the instruction program under execution. As a result, even in such a case that the instruction program is executed to which the power control instruction has been automatically applied by the instruction converting apparatus, the security aspect of the software can be improved. Also, the problems (bugs) of the software can be subdivided into the program bug which is caused by the instruction program itself written by the software developing person, and the program bug which is caused by the instruction which is automatically inserted by the compiler.

Also, in accordance with the present invention, both the section during which the power control operation is carried out, and the level of the power control operation can be freely set by employing the instruction statement contained in the instruction program. As a consequence, such a problem that the code size is increased and the operating speed is lowered can be suppressed in the minimum level, and the power control operation can be carried out in the fine mode. Also, the power control operation is not carried out at such a program portion in which the problem as to the security aspect may easily occur, because the power control instruction is inserted and replaced. Therefore, the security aspect of the instruction program can be improved.

Also, in accordance with the present invention, the instruction program can be automatically rearranged in such a manner that the instruction section where the operation of the operation resource can be stopped is made long by rearranging, or replacing the instructions. As a consequence, such an instruction section can be made long, during which the operation resource detected in the power control information analyzing operation is not actuated, and thus, the power consumption can be effectively reduced.

What is claimed is:

1. A microprocessor equipped with a power control function, comprising:
a power control permission setting unit, which previously sets information as to whether or not a power control operation is carried out; and
a power control output controller, which finally controls an output of a power control signal in accordance with the information set in the power control permission setting unit when a power control instruction is executed, the power control instruction separately designating power control operations with respect to operation resources of the microprocessor.

2. The microprocessor as claimed in claim 1, further comprising:
a power control register, which stores information as to operation resources whose power control operations should be carried out, which are designated by the power control instruction;
a power control circuit, which outputs power control signals for controlling electric power with respect to the respective operation resources based on the information stored in the power control register; and
a gate circuit, which gates the respective power control signals in accordance with the information set to the power control permission setting unit.

3. A microprocessor equipped with a power control function, comprising:
a processor state judging unit, which holds information as to whether or not a power control operation is carried out, which has been previously set every program ID applied to each of instruction programs, and which judges as to whether or not a program ID of an instruction program under execution corresponds to the program ID which has been set so as to perform the power control operation; and
a power control output controller, which finally controls an output of a power control signal in accordance with a judgement result of the processor state judging unit as to the instruction program under execution when a power control instruction is executed, the power control instruction separately designating power control operations with respect to operation resources of the microprocessor.

4. The microprocessor as claimed in claim 3, further comprising:
a power control register, which stores information as to operation resources whose power control operations should be carried out, which are designated by the power control instruction;
a power control circuit, which outputs power control signals for controlling electric power with respect to the respective operation resources based upon the information stored in said power control register; and
a gate circuit, which gates the respective power control signals in accordance with the judgement result of the processor state judging unit.

5. An instruction converting apparatus for optimizing an instruction program so as to suitably execute the optimized instruction program by a predetermined microprocessor, comprising:
a power control manager, which extracts power control management information by referring to an instruction statement which is written in the instruction program;
a power control information analyzer, which detect an operation resource based upon the power control management information extracted by the power control manager, the operation resource being not actuated for an instruction section having a predetermined length when the predetermined microprocessor is operated; and
a power control instruction applier, which applies an instruction related to a power control operation to the instruction program based upon the detected result of the power control information analyzer.

6. The instruction converting apparatus as claimed in claim 5, wherein:
the power control management information contains information for designating said predetermined length of the instruction section; and the power control information analyzer changes the predetermined length of the instruction section based upon the power control management information.

7. The instruction converting apparatus as claimed in claim 5, further comprising:
a instruction-independent operation resource table storing unit, which stores information as to whether or not each of the operation resources of the predetermined microprocessor is actuated every instruction;
wherein the power control information analyzer detects such an operation resource which is not actuated for the instruction section having the predetermined length when the predetermined microprocessor is operated based upon the information stored in the instruction-independent operation resource table storage unit.

8. A instruction converting apparatus for optimizing an instruction program so as to suitably execute the optimized instruction program by a predetermined microprocessor, comprising:
a power control analyzer, which detects an operation resource which is not actuated for an instruction section having a predetermined length when the predetermined microprocessor is operated; and
a power control instruction applier, which applies an instruction related to a power control operation to the instruction program based upon the detection result of the power control information analyzer;
wherein the power control information analyzer comprises,
a instruction reassembling unit, which reassembles the instruction program in such a manner that an instruction section is made long, during which an actuation of an operation resource can be stopped.

9. The instruction converting apparatus as claimed in claim 8 wherein:
the instruction reassembling unit corresponds to instruction rearranging unit which rearranges instructions while maintaining an instruction dependent relationship established in the instruction program.

10. The instruction converting apparatus as claimed in claim 8 wherein:
the instruction reassembling unit corresponds to instruction replacing unit which replaces one instruction contained in the instruction program by a replaceable instruction having the same process result as that of the one instruction.

11. An instruction converting method for optimizing an instruction-program so as to suitably execute the optimized instruction program by a predetermined microprocessor, comprising:
a power control managing step for extracting power control management information by referring to an instruction statement which is written in the instruction program;
a power control information analyzing step for detecting an operation resource based upon the power control management information extracted in the power control managing step, the operation resource being not actuated for an instruction section having a predetermined length when the predetermined microprocessor is operated; and
a power control instruction applying step for applying an instruction related to a power control operation to the instruction program based upon the detected result of the power control information analyzing step.

12. The instruction converting method as claimed in claim 11 wherein:
the power control management information contains information for designating said predetermined length of the instruction section; and the power control information analyzing step changes the predetermined length of the instruction section based upon the power control management information.

13. The instruction converting method as claimed in claim 11, wherein:
the power control information analyzing step refers to an instruction-independent operation resource table which stores thereinto information as to whether or not each of the operation resources of the predetermined microprocessor is actuated every instruction in order to detect such an operation resource which is not actuated for the instruction section having the predetermined length when said predetermined microprocessor is operated.

14. An instruction converting method for optimizing an instruction program so as to suitably execute the optimized instruction program by a predetermined microprocessor, comprising:
a power control analyzing step for detecting an operation resource which is not actuated for an instruction section having a predetermined length when said predetermined microprocessor is operated; and
a power control instruction applying step for applying an instruction related to a power control operation to the instruction program based upon the detection result of the power control information analyzing step; wherein:
the power control information analyzing step is comprised of: an instruction reassembling step for reassembling the instruction program in such a manner that an instruction section is made long, during which an actuation of an operation resource can be stopped.

15. The instruction converting apparatus as claimed in claim 14 wherein:
the instruction reassembling step rearranges instructions while maintaining an instruction dependent relationship established in the instruction program.

16. The instruction converting apparatus as claimed in claim 14 wherein:
the instruction reassembling step replaces one instruction contained in the instruction program by a replaceable instruction having the same process result as that of the one instruction.

17. A microprocessor wherein:
the microprocessor executes the instruction program converted by the instruction converting apparatus recited in any one of claim 5 to claim 10 so a to separately perform a power control operation with respect to an operation resource built in said microprocessor.

18. A microprocessor wherein:
the microprocessor executes the instruction program converted by the instruction converting method recited in any one of claim 11 to claim 16 so as to separately perform a power control operation with respect to an operation resource built in the microprocessor.
